(19) United States
(12) Patent Application Publication
(10) Pub. No.: US 2007/0004426 A1
(43) Pub. Date: Jan. 4, 2007

(54) Location information display for cellular device

(76) Inventors: Gerald W. Pfleging, Batavia, IL (US); Rachel M. Pfleging, Batavia, IL (US); George P. Wilkin, Bolingbrook, IL (US); David A. Zahn, Naperville, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/173,967

(22) Filed: Jun. 30, 2005

(51) Int. Cl. H04Q 7/20

(52) U.S. Cl. 455/456.1

(57) ABSTRACT

A method in one example comprises the steps of receiving, from a requesting user of a cellular device, a request for real-time location information for at least a second user; retrieving location data for the requesting user and the at least a second user; transmitting the location data for the requesting user and the at least a second user to the requesting user's cellular device; displaying the location data on the requesting user's cellular device using unique icons to identify the relative positions of the requesting user and the at least a second user; and periodically updating the location data and transmitting the updated location data to the requesting user's cellular device to maintain a real-time display of relative position information on the requesting user's cellular device.

### BACKGROUND

This application is directed generally to communication systems and in particular to telecommunication networks that support wireless communication, and is more particularly directed toward cellular telecommunication networks that support messaging and Internet access.

There are several systems in existence that allow the location of a particular device to be made known. Known systems generally operate on fixed, hard-wired computing devices and only show (or tell) the requesting user where the requested device is. Systems of this kind, however, are limited both in terms of portability and in the timeliness of the location information provided to the user.

### SUMMARY

The invention in one implementation encompasses a method. The method comprises the steps of receiving, from a requesting user of a cellular device, a request for real-time location information for at least a second user; retrieving location data for the requesting user and the at least a second user; transmitting the location data for the requesting user and the at least a second user to the requesting user's cellular device; displaying the location data on the requesting user's cellular device using unique icons to identify the relative positions of the requesting user and the at least a second user; and periodically updating the location data and transmitting the updated location data to the requesting user's cellular device to maintain a real-time display of relative position information on the requesting user's cellular device.

Another implementation of the invention encompasses a system. The system comprises means for receiving, from a requesting user of a cellular device, a request for real-time location information for at least a second user; means for retrieving location data for the requesting user and the at least a second user; means for transmitting the location data for the requesting user and the at least a second user to the requesting user's cellular device; means for displaying the location data on the requesting user's cellular device using unique icons to identify the relative positions of the requesting user and the at least a second user; and means for periodically updating the location data and transmitting the updated location data to the requesting user's cellular device to maintain a real-time display of relative position information on the requesting user's cellular device.

### DESCRIPTION OF THE DRAWINGS

Features of exemplary implementations of the invention will become apparent from the description, the claims, and the accompanying drawings in which:

FIG. 1 is a representation of a portion of a wireless telecommunication network.

FIG. 2 is a flow chart of a process for providing real-time location information.

FIG. 3 depicts a typical, hand-held, cellular communication device.

### DETAILED DESCRIPTION

The system of the present invention allows the real-time display of location information on any cellular device and shows relational distance information in real time in reference to the requesting user's location. This development allows a user to have convenient real-time access to the relative distance information for the person he or she is looking for.

In other words, the present invention is directed toward allowing a person or group of persons to get real-time information displayed on a cellular device indicating location of one or more cellular devices in reference to one another. The display on a cellular phone indicates where one or more persons are located with reference to the current location of the requesting user. This would allow a group of friends, family members, associates, etc., to find each other in large areas, such as convention halls, malls, amusement parks, or large work complexes, among other places.

A user who is interested in finding the location of another user's cellular device would send an SMS (Short Message Service) message to a predefined address with the cellular number of the person they wish to have displayed on their phone. They could also access an Internet-based system using a web browser or cellular application (MIDP/WAP/PocketPC) installed in the phone. An additional access method of a voice or tone-based Interactive Voice Response (IVR) system could also be used.

User “A”, whose location is being requested, receives a notification of the attempt from user “B” to find him or her. The notification could be any of the methods presented for the user “A” to request the location find. The user “A” can either allow or deny the request. The user may have a setting in the phone itself, or in the cellular carrier's network, to always accept or deny find requests.

There is the possibility that the user requesting or being requested has Global Positioning System (GPS) blocking enabled on the device he or she is using. If this is the case, in one embodiment of the invention, the phone will override the blocking of the GPS information and allow it to be used for this service. When the service terminates on either end, the phone or system providing the blocking will reinstate the blocking.

When the user being asked to be located answers the request (or if some timeout for non-response, or the device is unreachable), the user that requested the location is notified of the response. If the response was to accept, then the user's cellular device will start an application (if needed) to start displaying the information. The application will receive updates from a central server every X seconds (this can be a parameter set by the service provider and could be tweaked depending on the level of service desired) with information of where they are and where the user(s) are in relation to them. The application will display this information on the cellular device.

For example, the cellular user may be shown as a dot (or other suitable symbol, such as an “X” or a “+” for example) in the center of the display, and the user being located may be represented by an icon in the area of the screen that reflects his or her relative position with respect to the requesting user. Information markings or indicia next to the visual display icon may show the distance in feet/miles or meters/kilometers and/or the displayed icons may be hot-linked to allow display of more detailed location data when the user chooses to see it. This additional detail could include maps or predefined linked data that includes location or area name, for example. The information can be sent to the phone application (and the server) using an Internet connection from the phone, or through a series of SMS message exchanges. The location of each user can be found by GPS (Global Positioning System) or triangulation techniques.

As noted above, special symbols or icons may be used for each user being located, and may be predefined or picked from the application or access methods when setting up the locate request. The distance from the user may also be displayed. If a location technology is used that allows for the differentiation of heights (altitudes) of the devices to be determined, relative altitude information may also be displayed. For example, users could be on different floors of an office building.

Location information display service may be a pay-per-use service with charges being incurred for the amount of time used to track, or the number and frequency of the requests. This could also be a subscription service that would be available to any of the network users with a compatible phone at any time.

Many applications of a location display service will be inherently short range. Blocks could be built into the system to determine if a user is out of range for this service. In the alternative, the service may be provided with no distance limitations, and show the relative location information to the requesting user no matter where the other end devices are.

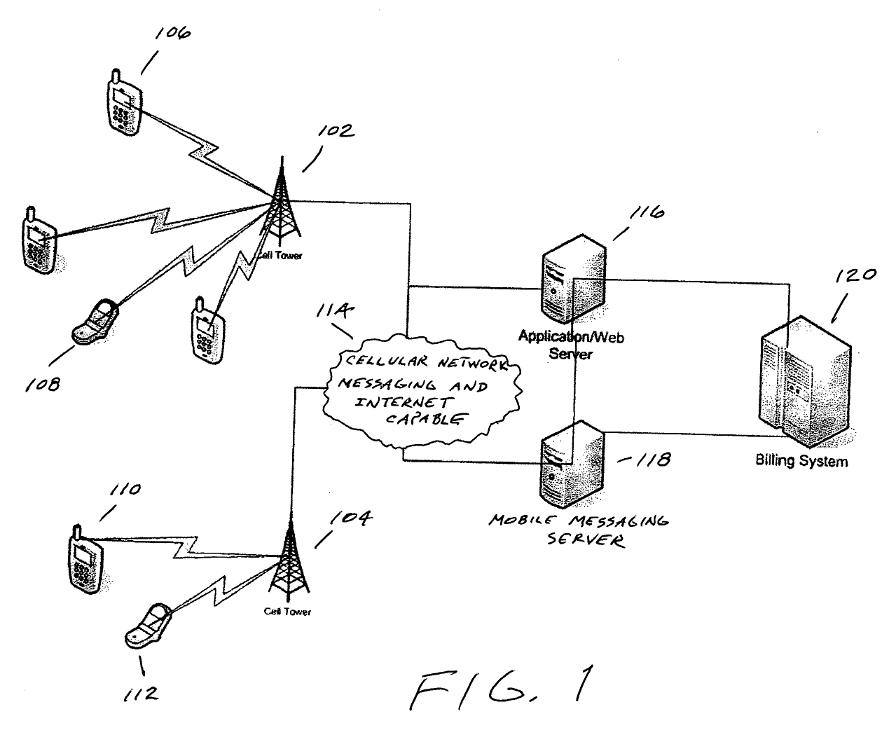

FIG. 1 depicts a portion of a typical cellular telecommunications system. A first cell site, with its associated antenna tower 102, is in communication with a variety of cellular devices, including conventional cellular handsets 108 and wireless terminal devices 106, such as PDAs (Personal Digital Assistants) that offer sophisticated display features and often provide complete keyboards, in addition to conventional cellular telephone features. A second cell site, with its associated tower 104, is also illustrated. This second cell site is also supporting communication with a variety of cellular devices 110, 112. In one embodiment of the invention, the cellular network 114 provides messaging capability as well as Internet access. Internet access is provided through a web server 116, while messaging is provided through a mobile messaging server 118. The system includes a sophisticated billing system 120 that is capable of charging each subscriber for airtime and features used.

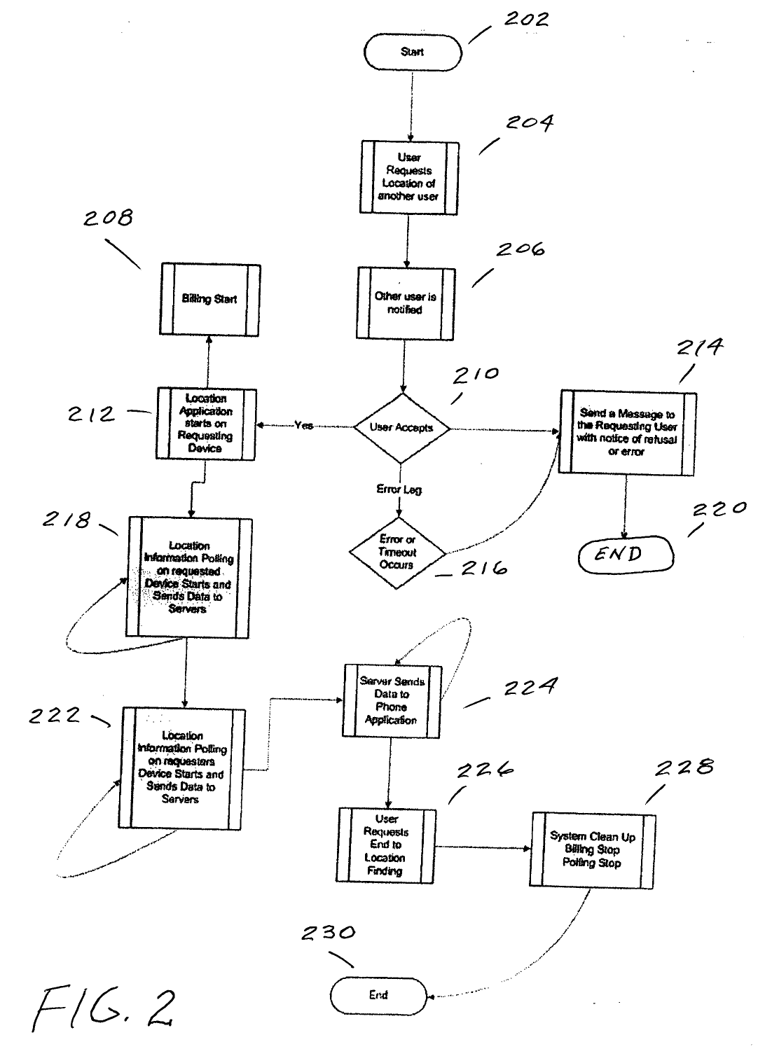

FIG. 2 is a flow chart illustrating how a location information system operates. A system user request the location of another user in step 204. Responsive to this request, the other user is notified in the subsequent process step 206, and the user decides whether to accept or reject the request in step 210.

In the event that the user refuses the request (step 210), an error indication (or timeout status) occurs in step 216. A message is then sent to the requesting user (step 214) and the process is terminated in the subsequent step 220.

If the user accepts, however, the location application is started on the requesting device (step 212), and the billing process 208 is initiated. Location information polling for the requested device is started (step 218), and so is location information polling for the requester (step 222). Location information is then transmitted to the phone application in step 224. Should the requesting user request an end to the location display (step 226), the subsequent process step 228 terminates the location polling processes and the billing application, and the process terminates in step 230.

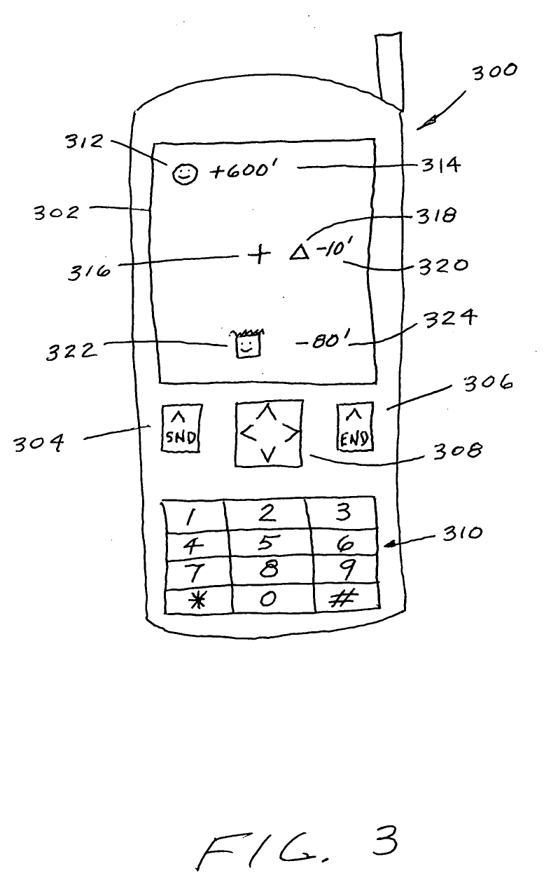

FIG. 3 depicts a typical cellular communication device 300. The cellular device 300 is equipped with a generous display area 302, as well as control keys such as SEND 304, END 306, and a navigation key 308, as well as a telephone keypad 310. When the location application is running, the location of the requesting user is displayed centrally and identified by an appropriate icon 316 that may be programmed by the user. Other users for whom location information has been requested are also identified by unique icons that may be defined by the user. For example, one of the users for whom location information has been requested is depicted by a unique icon 312 showing relative position with respect to the requesting user 312, and including an information field 314 that provides relative altitude information. Of course, this information field 314 may also include precise location data, if desired.

Two other users are also shown on the display 302 of the cellular device 300. One user is shown in relative position to the right of the requester, and identified by a unique icon 318. The associated numeric information field 320 indicates a relative altitude of minus ten feet. Another user is also identified by a unique icon 322, and the associated data field 324 provides relative altitude information.

The steps or operations described herein are just exemplary. There may be many variations to these steps or operations without departing from the spirit of the invention. For instance, the steps may be performed in a differing order, or steps may be added, deleted, or modified.

Although explemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. A method comprising the steps of:
(a) receiving, from a requesting user of a cellular device, a request for real-time location information for at least a second user;
(b) retrieving location data for the requesting user and the at least a second user;
(c) transmitting the location data for the requesting user and the at least a second user to the requesting user's cellular device;
(d) displaying the location data on the requesting user's cellular device using unique icons to identify the relative positions of the requesting user and the at least a second user; and
(e) periodically updating the location data and transmitting the updated location data to the requesting user's cellular device to maintain a real-time display of relative position information on the requesting user's cellular device.

2. The method of claim 1, further comprising the steps of:
(a1) notifying the at least a second user of the request for real-time location information; and
(a2) providing the at least a second user the opportunity to accept or deny the request.

3. The method of claim 1, wherein the step (b) of retrieving location data further comprises the step of retrieving location data based upon GPS location information.

4. The method of claim 1, wherein the step (b) of retrieving location data further comprises the step of retrieving location data based upon triangulation of the location of the at least a second user.

5. The method of claim 1, wherein the step (c) of transmitting the location data further comprises the steps of:
(c1) accessing altitude information for the requesting user and the at least a second user; and
(c2) transmitting location information and altitude information to the requesting user.

6. The method of claim 1, wherein the step (d) of displaying location information further comprises the steps of:
(d1) accessing an associated application program to retrieve unique icon information specified by the requesting user; and
(d2) displaying the unique icons in conjunction with numeric relative position information associated with at least the second user.

7. The method of claim 1, wherein the step (e) of periodically updating the location data further comprises the step of accessing predefined parameters established by the requesting user and determining desired real-time location information update interval.

8. The method of claim 1, further comprising the step of:
(f) billing the requesting user for transmission of location data.

9. The method of claim 8, wherein the step (f) of billing the requesting user further comprises billing the requesting user for both airtime and for GPS location information retrieval.

10. The method of claim 9, wherein the step (f) of billing the requesting user further comprises billing the requesting user a supplemental charge for any triangulation location determinations that are required in determining the location of the at least a second user.

11. A system comprising:
means for receiving, from a requesting user of a cellular device, a request for real-time location information for at least a second user;
means for retrieving location data for the requesting user and the at least a second user;
means for transmitting the location data for the requesting user and the at least a second user to the requesting user's cellular device;
means for displaying the location data on the requesting user's cellular device using unique icons to identify the relative positions of the requesting user and the at least a second user; and
means for periodically updating the location data and transmitting the updated location data to the requesting user's cellular device to maintain a real-time display of relative position information on the requesting user's cellular device.

12. The system of claim 11, further comprising:
means for notifying the at least a second user of the request for real-time location information; and
means for providing the at least a second user the opportunity to accept or deny the request.

13. The system of claim 11, wherein the means for retrieving location data further comprises means for retrieving location data based upon GPS location information.

14. The system of claim 11, wherein the means for retrieving location data further comprises means for retrieving location data based upon triangulation of the location of the at least a second user.

15. The system of claim 11, wherein the means for transmitting the location data further comprises:
means for accessing altitude information for the requesting user and the at least a second user; and
means for transmitting location information and altitude information to the requesting user.

16. The system of claim 11, wherein the means for displaying location information further comprises:
means for accessing an associated application program to retrieve unique icon information specified by the requesting user; and
means for displaying the unique icons in conjunction with numeric relative position information associated with at least the second user.

17. The system of claim 11, wherein the means for periodically updating the location data further comprises means for accessing predefined parameters established by the requesting user and means for determining desired real-time location information update interval.

18. The system of claim 11, further comprising:
means for billing the requesting user for transmission of location data.

19. The system of claim 18, wherein the means for billing the requesting user further comprises means for billing the requesting user for both airtime and for GPS location information retrieval.

20. The system of claim 19, wherein the means for billing the requesting user further comprises means for billing the requesting user a supplemental charge for any triangulation location determinations that are required in determining the location of the at least a second user.
